(19) United States
(12) Patent Application Publication
(10) Pub. No.: US 2007/0265865 A1
(43) Pub. Date: Nov. 15, 2007

(54) Computer based live resume processing system

(76) Inventors: Jeffrey A. Cox, Scottsdale, AZ (US); Pamala Mimms-Cox, Scottsdale, AZ (US)

Correspondence Address: ROBERT A. PARSONS, 4000 N. CENTRAL AVENUE, SUITE 1220, PHOENIX, AZ, 85012, US

(21) Appl. No.: 11/430,648

(22) Filed: May 9, 2006

(51) Int. Cl. G06Q 10/00; G06Q 30/00

(52) U.S. Cl. 705/1

(57) ABSTRACT

A method of operating a computer based candidate/employer live resume information processing system includes a step of providing a system including a browser coupled to a computer network for interactive communication with candidates for jobs and potential employers, streaming video and text storage apparatus coupled to the browser for receiving information from the browser and for providing information to the browser. The method also includes receiving and storing a live resume including streaming video and text associated with a job candidate and a job description and employer information associated with a potential employer. A list of stored live resumes substantially corresponding to the job description is provided in response to a query from a potential employer.

### FIELD OF THE INVENTION

This invention relates generally to a service for providing communication between job candidates and employers and, more particularly, to computer software to provide hiring services over a network.

### BACKGROUND OF THE INVENTION

A company's success often depends on the quality of the employees hired. Hiring a skilled and proficient employee base is an expensive and time-consuming process. Traditionally, this is done by advertising or by having the potential candidates send in their resumes to the company. These options, however, have several problems. One is that the company generally hires and maintains a staff of people to sort through a large number of resumes to evaluate potential candidates. Also, it is difficult for the company to effectively evaluate a candidate by only looking at the candidate's resume. For a better evaluation, the candidate is typically brought to the company for a face-to-face interview, which is costly and time consuming. This is especially true if the candidate lives far away from the company and must travel to the interview.

As a result, the costs of the employee hiring process can run into the hundreds of thousands of dollars. This makes an unsuccessful interview a regretful and expensive affair. For instance, taking into account basic hiring expenses, such as employee orientation, legal fees, compliance, employee relations and employment liability, the typical annual human resource cost per employee can easily exceed $150,000 for a medium to large size company. Accordingly, there is a need for an improved employee hiring process that is less costly and more efficient.

It would be highly advantageous, therefore, to remedy the foregoing and other deficiencies inherent in the prior art.

Accordingly, it is an object of the present invention to provide a new and improved computer based candidate/employer live resume information processing system and method of operation.

### BRIEF SUMMARY OF THE INVENTION

Briefly, to achieve the desired objects of the instant invention in accordance with a preferred embodiment thereof, provided is a method of operating a computer based candidate/employer live resume information processing system. The method includes a step of providing a live resume information processing system including a browser coupled to a computer network for interactive communication with candidates for jobs and potential employers, streaming video and text storage apparatus coupled to the browser for receiving information from the browser and for providing information to the browser. The method also includes a step of receiving and storing a live resume including streaming video and text associated with a job candidate and receiving and storing a job description and employer information associated with a potential employer. A list of stored live resumes substantially corresponding to the job description is provided in response to a query from a potential employer.

To further achieve the desired objects of the instant invention a method of operating a computer based candidate/employer live resume information processing system having a browser with a software program coupled to a computer network for interactive communication with candidates for jobs and potential employers, and streaming video and text storage apparatus coupled to the browser for receiving information from the browser and for providing information to the browser is contemplated. The method includes activating the software program from a remote computer through the computer network and communicating with the browser using the software program. Using the software program with the remote computer, a streaming video and text resume corresponding to a job candidate is provided. Also, the streaming video and text resume is stored in the streaming video and text storage apparatus using the software program.

To further achieve the desired objects of the instant invention a method of operating a computer based candidate/employer live resume information processing system having a browser with a software program coupled to a computer network for interactive communication with candidates for jobs and potential employers, and storage apparatus coupled to the browser for receiving information from the browser and for providing information to the browser is contemplated. The method includes the steps of activating the software program from a remote computer through the computer network and communicating with the browser using the software program. Using the software program with the remote computer, information is provided and stored in the storage apparatus applying to a job description and employer information associated with a potential employer. Also, using the software program with the remote computer, live resumes stored in the storage apparatus are searched for a job candidate having predetermined qualifications for a job, the software program provides a list of potentially acceptable job candidates. When a job candidate is selected from the list, the software program provides a live resume, including streaming video and text, associated with the job candidate selected.

### BRIEF DESCRIPTION OF THE DRAWINGS

The foregoing and further and more specific objects and advantages of the invention will become readily apparent to those skilled in the art from the following detailed description taken in conjunction with the drawings in which:

FIG. 1 is a simplified flow diagram of one embodiment of a method, in accordance with the present invention, of providing a resume;

FIGS. 2a and 2b are embodiments of a resume with video and text portions in accordance with the present invention;

FIG. 3 is a simplified flow diagram of one embodiment of a method, in accordance with the present invention, of finding a candidate;

FIG. 4 is a simplified flow diagram of one embodiment of a method, in accordance with the present invention, of facilitating communication between a job candidate and an employer; and

FIG. 5 is a simplified block diagram of a computer based candidate/employer live resume information processing system in accordance with the present invention.

### DETAILED DESCRIPTION OF THE DRAWINGS

The present invention includes live resume information processing apparatus 10 for allowing candidates for jobs and employers with available jobs to conveniently communicate. Also contemplated are various methods for the use of apparatus 10 by candidates and employers. Employer refers to any person or company seeking to employ a candidate. Candidate refers to any person in search of employment, including a person already working for a specific employer searching for employment with that same employer. Generally, apparatus 10 is connected to a publicly available computer network 12, such as the World Wide Web, and offers the service of communication between potential candidates for jobs and employers with potential jobs. However, it will be understood that apparatus 10 can be an internal network, such as an intranet, to an organization or employer, such as a large company.

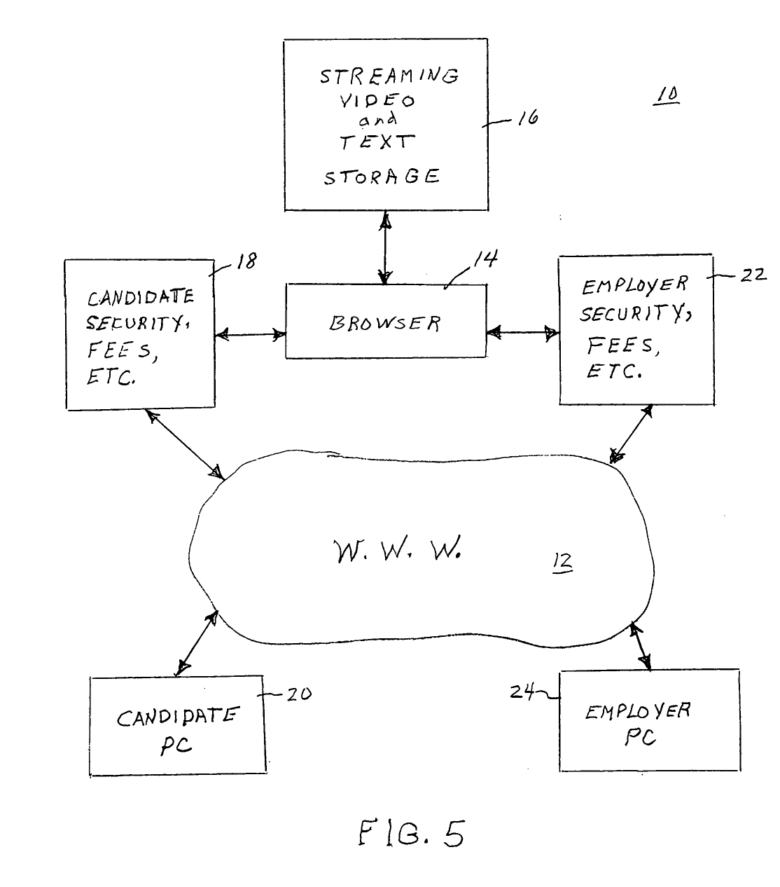

A simplified version of apparatus 10, illustrated in FIG. 5, includes a browser or browsers 14 having storage apparatus 16 coupled thereto for the storage of live resumes including streaming video and text submitted by candidates for jobs. Browser 14 is coupled through interface apparatus 18, including such functions as candidate security and any fees required, to a candidate PC 20 through computer network 12. As will be explained in more detail below, the candidate not only submits a live resume through computer network 12 to browser 14 for storage in storage apparatus 16 but may review and delete or edit the live resume at a later time. As an example, live resume refers to a summary of one's works, accomplishments, experiences, and qualifications listed in an interactive format in a visual media fashion such as streaming video, another visual media format, or any verbal media format.

Similarly, browser 14 is coupled through interface apparatus 22, including such functions as employer security and any fees required, to an employer PC 24 through computer network 12. As will be explained in more detail below, the employer not only submits information relating to available jobs through computer network 12 to browser 14 for storage in storage apparatus 16 but may review and delete or edit the job information at a later time.

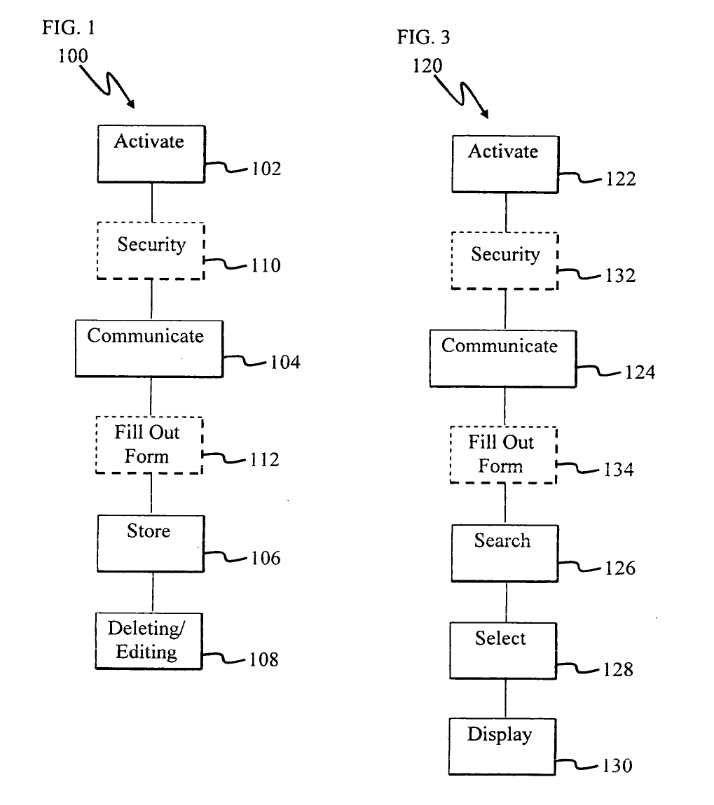

Referring specifically to FIG. 1, a simplified flow diagram 100 is illustrated of a method of providing a live resume to apparatus 10. The method is useful to facilitate finding a job and allows a candidate to provide a resume for viewing by potential employers, wherein the resume includes a text portion and a streaming video portion. The candidate is typically an internal or external job candidate, but the person can also be someone working with or for the job candidate to help him or her find employment. The live resume providing method is preferably implemented by or through candidate PC 20 in communication with publicly available computer network 12, such as the World Wide Web. Candidate PC 20 and computer network 12 generally use web pages that are linked together in a manner known in the art. The web pages used by the live resume providing method are typically programmed using a web-based computer language, such as Hypertext Mark-up Language (HTML), Extensible Hypertext Markup Language (XHTML), Extensible Markup Language (XML), PHP, Perl, or a similar programming language. PHP and Perl are widely-used general-purpose scripting languages that are especially suited for Web development and can be embedded into other web-based computer languages, such as HTML, XHTML, XML, etc.

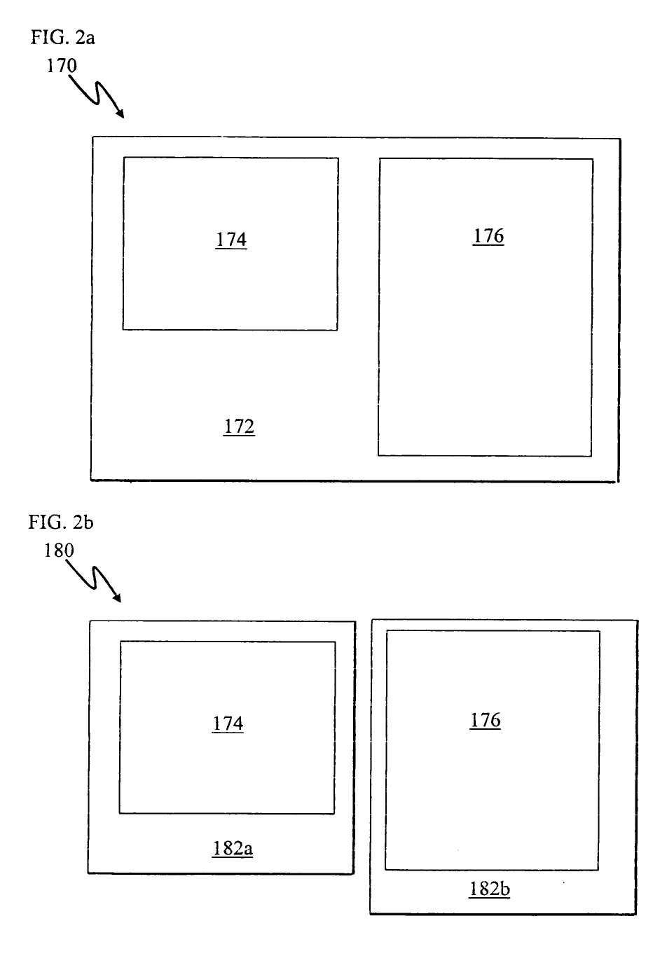

In accordance with the invention and as shown in FIG. 2a, a live resume 170 includes a text portion 174 and a streaming video portion 176 which are intended to be viewed by a potential employer to evaluate the candidate and are provided for display by a web browser 172, included as a portion of browser 14. Live resume 170 is intended to be viewed by a potential employer or someone working with or for the employer to find job candidates. Further, the text and video portions 174 and 176 can be viewed and/or changed remotely by the candidate through candidate PC 20. The changes typically include editing and/or deleting. In another embodiment shown in FIG. 2b, a resume 180 is included in a web browser 182a (a portion of browser 14) which provides resume portion 174 for display and a separate web browser 182b (also a portion of browser 14) which provides video portion 176 for display. An advantage of this embodiment is that the user can arrange text and video portions 174 and 176 to provide a desired display arrangement.

The live resume providing method illustrated by diagram 100 in FIG. 1 provides several advantages for the candidate. One advantage is that the candidate can record, delete, and/or edit the video until he or she is satisfied with the results of the video. Another advantage is that the candidate can submit multiple live resumes with the same or different text and videos to target jobs in different employment areas. Further, the live resume providing method allows the candidate to apply for a large number of jobs more efficiently because it allows for the wider collection and dissemination of information about the candidate to potential employers. Because the live resume providing method is network based, these jobs can be located near the candidate or at a remote location, such as in a different city, state, or country. This reduces the need for time-consuming and costly face-to-face interviews. Hence, the live resume providing method provides the job candidate with a way to utilize a web-based application to help him or her find a job.

A further advantage is that the live resume provides more information about the candidate. This is because the live resume includes both text and streaming video portions that can be viewed by a potential employer. This provides the potential employer with more information about the candidate. For example, the potential employer can learn about the candidate's presentation qualities before, or even instead of, spending the resources for a meeting. This reduces the need for time-consuming and costly face-to-face interviews and improves the efficiency of the conventional recruitment processes.

In this embodiment, the live resume providing method of flow diagram 100 (FIG. 1) includes a step 102 of activating a software program, which can be of many different types. In this embodiment, it is an HTML based internet web browser. The software program is operated on a local computer, such as candidate PC 20 or a laptop. It can also be operated on a personal digital assistant or another graphical interface device, all of which are intended to be encompassed in the term “candidate PC”.

A step 104 of flow diagram 100 includes communicating with a remote computer (herein a portion of browser 14) using the software program. The local and remote computers are typically in communication through computer network 12 and web browser 14 facilitates communication there between. The communication can be through many different types of links, such as a land line, optical, or wireless link, etc.

A step 106 of flow diagram 100 includes storing a streaming video and text resume, such as those shown in FIG. 2a or 2b, in storage apparatus 16 through the remote computer (browser 14) using the software program. The video and text resumes may be stored in the memory of the remote computer or in special memory apparatus any or all of which form storage apparatus 16. This memory can be a hard drive, for example, or another type of computer memory device. The information can also be stored on another computer, such as a server, in communication with the remote computer. It is intended herein to include any such memory or storage devices in the general term “storage apparatus”.

The video and text resumes correspond to the candidate and convey relevant job and/or personal information about him or her. In some examples, the candidate stores multiple video and text resumes on the remote computer using the software program. An advantage of storing multiple corresponding video and text resumes is that the candidate can target different types of jobs in many different locations. In these examples, the different video resumes, and their corresponding text resume, are typically customized to a particular job to increase the likelihood of receiving a desired job offer. The jobs can be in the same or different industries and often require different job skills that are best highlighted with different video and text resumes.

In this example, the method illustrated by flow diagram 100 further includes a step 108 of changing the video and/or text resumes remotely, e.g. from candidate PC 20. The changes generally include deleting and/or editing them. The video resume or portions of it can also be rerecorded in some instances. To do this, the text and video resumes are displayed by the software program through the same web browser (FIG. 2a) or different web browsers (FIG. 2b) for the candidate to view. In some embodiments, a form, as discussed below, can also be edited and/or deleted remotely by the candidate. Further, the text and/or video resumes are typically uploaded remotely. This is useful so that the candidate can change the information provided to the employer at his or her convenience.

In some embodiments, the method illustrated by flow diagram 100 includes a step 110, between steps 102 and 104, of requesting security input to access the computer through a security interface such as interface apparatus 18. Security interface apparatus 18 reduces the likelihood of unauthorized access to the information stored by the remote computer (i.e. browser 14 and storage apparatus 16). Most security interfaces, for example, request the input of a username that uniquely identifies the user and a password.

In some embodiments, the method illustrated by flow diagram 100 includes a step 112, between steps 104 and 106, of having a new candidate fill out a form prior to storing the video and text resumes on the remote computer (i.e. browser 14 and storage apparatus 16) using the software program. The form preferably receives information regarding the new candidate's personal information, such as address, phone number, e-mail address, etc. The form can also receive information regarding the new candidate's employment and life history and may, at that time, request any fees required by the service. The form is typically stored on the remote computer (i.e. browser 14 and storage apparatus 16) and displayed on the local computer as a registration page. The form is useful so that the remote computer (i.e. browser 14 and storage apparatus 16) has a record of a candidate that has previously communicated with it. In this way, the previous candidate does not need to provide the remote computer (i.e. browser 14 and storage apparatus 16) with his or her information for each visit. The information can also be used to identify the previous candidate.

It should be noted that the steps of the method of flow diagram 100 can be performed in many different orders depending on the situation and/or the design of the software program. As a result, the particular order of steps described herein is for illustrative purposes only. It should also be noted that the steps of the method are generally performed by the candidate, but they can be performed by a job searcher, such as a job finding agency, for example.

Turning now to FIG. 3, a simplified flow diagram of one embodiment of a method of finding a job candidate is illustrated by flow diagram 120. The method of flow diagram 120 provides several advantages for a potential employer searching for a candidate. One advantage is that the live resume provides more information about the candidate because the potential employer is provided with the text portion of the candidate's resume as well as the streaming video portion. In this manner, the potential employer is provided with more information about the prospective candidate before wasting valuable time and money. Another advantage is that the potential employer can view the streaming video and text online before spending time and money to bring the candidate in for a face-to-face interview. This allows the potential employer to reduce the number of interviews, many or all of which may not be productive. Hence, the method provides the potential employer a less expensive and more efficient way to evaluate and review a large number of job candidates.

In this embodiment, the method illustrated by flow diagram 120 includes a step 122 of activating a software program, which can be the same or similar to that discussed above with flow diagram 100. A step 124 includes communicating with a remote computer (browser 14 and storage apparatus 16) which is storing information about a plurality of candidates. It should be noted that steps 122 and 124 can be the same or similar to steps 102 and 104 described above in conjunction with flow diagram 100. In this example, each candidate provides separate video and corresponding text resumes to be stored in storage apparatus 16 by browser 14 (the remote computer).

A step 126 includes searching the stored information for a desired candidate having qualifications for a job. The search can be done remotely and generally involves searching the stored text resumes for keywords. There are many different searching algorithms known in the art that can be used and search features are typically included with web pages. The results of the search are preferably displayed as a list at employer PC 24 by web browser 14.

In accordance with one embodiment of the invention, the video and text resumes are both displayed in the same web browser (FIG. 2a), the streaming video resume being prerecorded and stored. An advantage of prerecording the streaming video resume is that it can be viewed and changed by the candidate before it is viewed by a potential employer. This is useful because the number of mistakes can be reduced and the quality is improved. In another embodiment, however, the video and text resumes are provided for display by different browsers (FIG. 2b). An advantage of displaying the video and text resumes through different browsers is that the separate browsers can be arranged to display the video and text resumes according to the candidate's display preference.

A step 128 in flow diagram 120 includes selecting a desired candidate. The desired candidate is typically one who was found in response to step 126. The desired candidate is generally selected from the list discussed above. A step 130 includes displaying, with the web browser, the video and text resumes corresponding to the desired candidate in response to the desired candidate being selected. The desired candidate is generally selected by the potential employer providing an input to the computer. The input is typically the activation of a button on a mouse, but it can be another selector known in the art, such as the pressing of a key on a keyboard. The selection of the desired candidate is preferably done remotely for reasons discussed above.

In some embodiments, the method illustrated by flow diagram 120 includes a step 132, between steps 122 and 124, of requesting security input to access the computer through security interface apparatus 22. This step is the same or similar to step 110 discussed above in conjunction with FIG. 1.

In some embodiments, the method illustrated by flow diagram 120 includes a step 134, between steps 124 and 126, of having a new potential employer fill out a form prior to searching the video and text resumes on the remote computer using the software program. The form preferably receives information regarding the new employer's contact information, such as address, phone number, e-mail address, etc. and any fees required by the service. The form can also receive information regarding the new employer's employment needs. The form is typically stored on the remote computer (browser 14 and storage apparatus 16) and is displayed on employer PC 24 as a registration page. The form is useful so that the remote computer (browser 14 and storage apparatus 16) has a record of a potential employer that has previously communicated with it. In this way, the potential employer does not need to provide the remote computer (browser 14 and storage apparatus 16) with his or her information for each visit. The information can also be used to identify the new employer.

It should be noted that the steps of the method illustrated by flow diagram 120 can be performed in many different orders depending on the situation and/or the design of the software program. As a result, the particular order of steps described herein is for illustrative purposes only. It should also be noted that the steps of the method illustrated by flow diagram 120 are generally performed by a potential employer, but they can be performed by a candidate searcher, such as job recruitment personnel, for example.

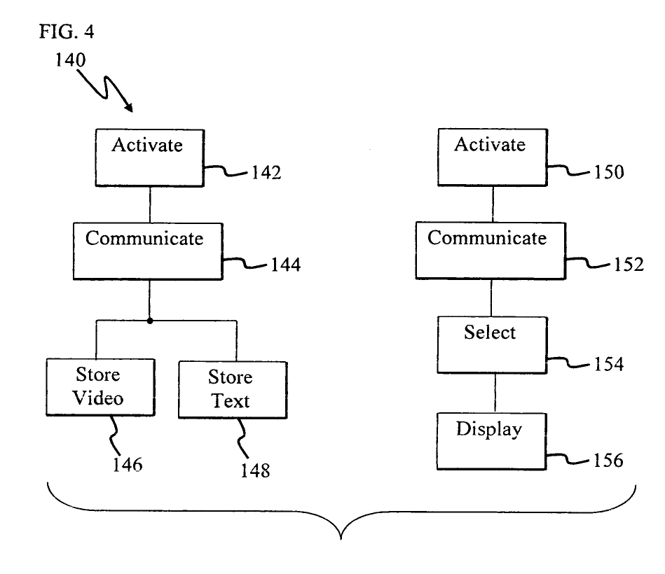

Referring additionally to FIG. 4, a simplified flow diagram 140 is illustrated describing one embodiment of a method of facilitating communication between a job candidate and a potential employer. It should be noted that some of the steps in the method described by flow diagram 140 are the same or similar to the steps in the methods illustrated by flow diagrams 100 and 120 discussed above. The method of flow diagram 140 includes a step 142 of activating a first web browser, generally browser 14 or a portion thereof. A step 144 includes using the first web browser to communicate with a database in storage apparatus 16. The database can be of many different types and is usually used to store a collection of data arranged for ease and speed of search and retrieval. The database is usually stored on a hard drive or another computer memory circuit known in the art and referred to herein generically as storage apparatus 16.

Steps 146 and 148 of flow diagram 140 include storing in the database streaming video and text resumes, respectively, corresponding to a candidate. The storing of the video and text resumes is done using web browser 14. The video and text resumes are typically digital data flowed through the communication link between web browser 14 and candidate PC 20. In accordance with the invention, the text and video resumes are uploaded remotely, with the streaming video resume being prerecorded in most examples. In the preferred embodiment, the live resume includes visual and audio information corresponding to the candidate and the first web browser 14 allows the remote editing of the video and/or text resumes through the communication link.

A step 150 of flow diagram 140 includes activating a second web browser, which can be the same or similar to the first web browser and included in Browser 14 of FIG. 5. Step 150 is generally performed by a potential employer who is seeking a candidate to perform a particular job. A step 152 includes using the second web browser to communicate with the database stored in storage apparatus 16. A step 154 includes searching the database for a desired candidate having predetermined qualifications for the particular job. Step 154 searches the video and text resumes stored in steps 146 and 148, respectively. A step 156 includes displaying the video and text resumes corresponding to the desired candidate in response to the desired candidate being selected using the second web browser. This can be done as shown in FIG. 2a or 2b, as discussed above. It should be noted that the steps of the method described by flow diagram 140 can be performed in many different orders depending on the situation and/or the design of the software program. As a result, the particular order of steps described herein is for illustrative purposes only.

The present invention is described above with reference to preferred embodiments. However, those skilled in the art will recognize that changes and modifications may be made in the described embodiments without departing from the nature and scope of the present invention. Various further changes and modifications will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. A method of operating a computer based candidate/employer live resume information processing system comprising the steps of:
providing a live resume information processing system including a browser coupled to a computer network for interactive communication with candidates for jobs and potential employers, streaming video and text storage apparatus coupled to the browser for receiving information from the browser and for providing information to the browser;
receiving, through the browser and the computer network, a live resume including streaming video and text associated with a job candidate;
storing the live resume in the streaming video and text storage apparatus;
receiving, through the browser and the computer network, a job description and employer information associated with a potential employer; and
providing, through the browser and the computer network, a list of stored live resumes substantially corresponding to the job description in response to a query from the potential employer.

2. A method as claimed in claim 1 wherein the step of providing includes providing a candidate security interface between the browser and the computer network.

3. A method as claimed in claim 1 wherein the step of providing includes providing a potential employer security interface between the browser and the computer network.

4. A method as claimed in claim 1 including a step of receiving and storing editing information applying to the live resume associated with the job candidate.

5. A method as claimed in claim 4 wherein the received and stored editing information includes modifications to one of the streaming video and the text.

6. A method as claimed in claim 4 wherein the received and stored editing information deletes the live resume.

7. A method as claimed in claim 1 including a step of receiving and storing editing information applying to one of the job description and employer information.

8. A method of operating a computer based candidate/employer live resume information processing system having a browser with a software program coupled to a computer network for interactive communication with candidates for jobs and potential employers, and streaming video and text storage apparatus coupled to the browser for receiving information from the browser and for providing information to the browser, the method comprising the steps of:
activating the software program from a remote computer through the computer network;
communicating with the browser using the software program; and
using the software program with the remote computer, providing a streaming video and text resume corresponding to a job candidate, and storing the streaming video and text resume in the streaming video and text storage apparatus using the software program.

9. A method as claimed in claim 8 wherein, subsequent to the step of providing a streaming video and text resume, the step of communicating with the browser includes editing the streaming video and text resume.

10. A method as claimed in claim 9 wherein the step of editing the streaming video and text resume includes modifications to one of the streaming video and the text.

11. A method as claimed in claim 9 wherein the step of editing the streaming video and text resume includes deleting the streaming video and text resume.

12. A method of operating a computer based candidate/employer live resume information processing system having a browser with a software program coupled to a computer network for interactive communication with candidates for jobs and potential employers, and storage apparatus coupled to the browser for receiving information from the browser and for providing information to the browser, the method comprising the steps of:
activating the software program from a remote computer through the computer network;
communicating with the browser using the software program;
using the software program with the remote computer, providing and storing information in the storage apparatus applying to a job description and employer information associated with a potential employer;
using the software program with the remote computer, searching live resumes stored in the storage apparatus for a job candidate having predetermined qualifications for a job, the software program providing a list of potentially acceptable job candidates; and
selecting a job candidate from the list, the software program providing a live resume, including streaming video and text, associated with the job candidate selected.
